(19) United States
(12) Patent Application Publication
(10) Pub. No.: US 2014/0376023 A1
(43) Pub. Date: Dec. 25, 2014

(54) PRINTING APPARATUS, METHOD OF CONTROLLING THE SAME AND STORAGE MEDIUM

(71) Applicant: CANON KABUSHIKI KAISHA, Tokyo (JP)

(72) Inventors: Makoto Anno, Tokyo (JP); Hideyuki Okada, Kawasaki-shi (JP)

(21) Appl. No.: 14/298,033

(22) Filed: Jun. 6, 2014

(30) Foreign Application Priority Data
Jun. 21, 2013 (JP) 2013-131053

(51) Int. Cl. G06K 15/00

(52) U.S. Cl. CPC G06K 15/4065
USPC 358/1.14

(57) ABSTRACT

A printing apparatus, and a method of controlling the same, holds a job for which execution of printing is not instructed and stores a job for which execution of printing unit is instructed in a storage unit. It is determined whether or not a sheet necessary to complete the held job is set in a sheet feed source, and if there is a print job that uses a sheet being to be used by the job for which it is determined that the sheet necessary to complete the job is set in the sheet feed source, it is notified that the print job is stored in the storage unit.

### BACKGROUND OF THE INVENTION

1. Field of the Invention

The present invention relates to a printing apparatus, a method of controlling the same, and a storage medium.

2. Description of the Related Art

When sheets required by a printing apparatus for executing printing are insufficient upon processing a print job, printing is stopped. Then, in order to cancel the state and resume printing, work by an operator is required. Here, the occurrence of downtime in which printing is stopped is very much seen as problematic in printing job sites. For this reason, it is important to avoid the occurrence of downtime, or to keep it to a minimum. However, conducting operations with an operator working exclusively for one printing apparatus to insure against the occurrence of a cause leading to downtime is very inefficient. So, designs have been proposed so that the factors that lead to downtime themselves do not occur in the first place. One of these is an approach of confirming prior to job processing initiation whether or not the sheets necessary for completing the print job are present in the printing apparatus and only initiating processing for print jobs for which it is determined that the sheets are present (for example, refer to U.S. Pat. No. 6,823,147). Also, regarding print jobs for which it is determined that the sheets are not present, processing is initiated after having eliminated the problem. Initiating the processing here does not indicate only print processing, but also includes an input job of inputting into a print queue. By virtue of this approach, regarding print jobs for which it is checked whether the sheets are present prior to job processing initiation, it is guaranteed that execution of the job will complete without being suspended. However, in the technique recited in U.S. Pat. No. 6,823,147, there is no guarantee, when a print job is reserved, that the resources needed to be able to execute the reserved print job will still exist when the reserved print job is executed.

In contrast to this, Japanese Patent Laid-Open No. 2008-221469 discloses prohibiting sheet feed source usage and setting changes based on job information of a reserved print job from the time when the job has been input until the job is executed at a reserved time for the reserved print job.

However, in the approach of Japanese Patent Laid-Open No. 2008-221469, even with a print job of one page, because sheets cannot be fed from the sheet feed source that the reserved print job uses, in a state in which a print job is reserved, there is a possibility that a print job that cannot be executed will occur.

Also, a case in which after a resource check is performed and the execution of the print job is initiated, there is a change in the status of the resources is not considered. For this reason, while there is no problem at the point in time when the print job is initiated, there is the possibility that a resource deficiency will occur when the print job is executed when afterwards another print job that was queued is executed, or setting of a feed tray is changed by a user.

### SUMMARY OF THE INVENTION

An aspect of the present invention is to eliminate the above-mentioned problems with the conventional techniques.

A feature of the present invention is to provide a technique by which it can be determined before initiation of the print job whether or not the sheets are contained in a printing apparatus such as to be able to complete a print job.

According to an aspect of the present invention, there is provided a printing apparatus, comprising: a holding unit configured to hold a job for which execution of printing is not instructed; a storage unit configured to store a job for which execution of printing unit is instructed; a determination unit configured to determine whether or not a sheet necessary to complete the job held in the holding unit is set in a sheet feed source; and a display unit configured to display a job held in the holding unit and a determination result by the determination unit for the job, wherein the display unit further notifies that a print job is stored in the storage unit, wherein the print job uses a sheet being to be used by the job for which it is determined by the determination unit that the sheet necessary to complete the job is set in the sheet feed source.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 depicts a view for explaining a configuration of a printing system according to embodiments of the present invention.

FIG. 2 is a block diagram for explaining a hardware configuration of a printing apparatus according to embodiments.

FIG. 3 is a functional block diagram for explaining software that a controller of the printing apparatus according to embodiments executes, and data managed by the controller.

FIG. 4A depicts a view for explaining a data configuration of job data according to embodiments.

FIG. 4B depicts print queue data according to embodiments.

FIGS. 5A-5C depict views for respectively explaining a data configuration of hold queue data, user setting values, and sheet feeding cassette setting values according to embodiments.

FIG. 6A depicts a view for showing an example of a setting screen for setting an “unconfirmed job” processing mode.

FIG. 6B depicts a view for showing an example of a screen for setting an initiation timing for executing the processing mode on an unconfirmed job.

FIG. 7 depicts a view for illustrating an example of a user operation screen of a media mismatch determination function according to embodiments.

FIG. 8 is a flowchart for describing processing that a mismatch processing section performs corresponding to a print job stacked in a hold queue buffer in the printing apparatus according to embodiments.

FIG. 9 is a flowchart for describing processing in a case where a media mismatch occurs in the printing apparatus according to a first embodiment.

FIG. 10 is a flowchart for describing processing in a case where in step S907 of FIG. 9 printing is not performed.

FIG. 11 is a flowchart for describing print processing of an unconfirmed job of step S1006 of FIG. 10.

FIG. 12 is a block diagram for showing a configuration of a printing system according to a second embodiment.

FIG. 13 is a flowchart for describing processing by the printing apparatus according to the second embodiment.

FIG. 14 is a flowchart for describing processing by the printing apparatus which is executed continuing from the processing shown in the flowchart of FIG. 13 in the second embodiment.

FIG. 15 depicts a view for showing an example of a screen that the control unit in step S1404 displays.

FIG. 16 is a flowchart for describing processing when a print job, for which a mismatch inspection is performed, is executed in the printing apparatus according to the second embodiment.

FIGS. 17A and 17B depict views for showing examples of user confirmation screens in the second embodiment.

FIG. 18A is a flowchart for describing processing executed continuing from step S1607 of FIG. 16 in the second embodiment.

FIG. 18B depicts a view for showing an example of a confirmation screen for confirming whether or not to continue execution of a print job for which print processing in progress in the second embodiment.

### DESCRIPTION OF THE EMBODIMENTS

Embodiments of the present invention will now be described hereinafter in detail, with reference to the accompanying drawings. It is to be understood that the following embodiments is not intended to limit the claims of the present invention, and that not all of the combinations of the aspects that are described according to the following embodiments are necessarily required with respect to the means to solve the problems according to the present invention.

In the present embodiment, explanation will be given of an example of a printing apparatus having a function (referred to as a media mismatch determination function) for confirming, prior to the processing of the print job initiating, whether sheets necessary for completing a print job are contained in a sheet feed source. A received print job is first saved into a hold queue, and after confirming that sheets necessary for completing the print job are contained in the sheet feed source, the job for which execution of that print job is initiated is called a “non-mismatch job”. On the other hand, a job for which execution of a print job stored in the hold queue is initiated without performing this kind of confirmation, and a print job input into a print queue directly without passing through the hold queue is called an “unconfirmed job”. For example, a generic print job such as one input into a print queue of the printing apparatus from a print driver of a PC and printed is classified as an “unconfirmed job”.

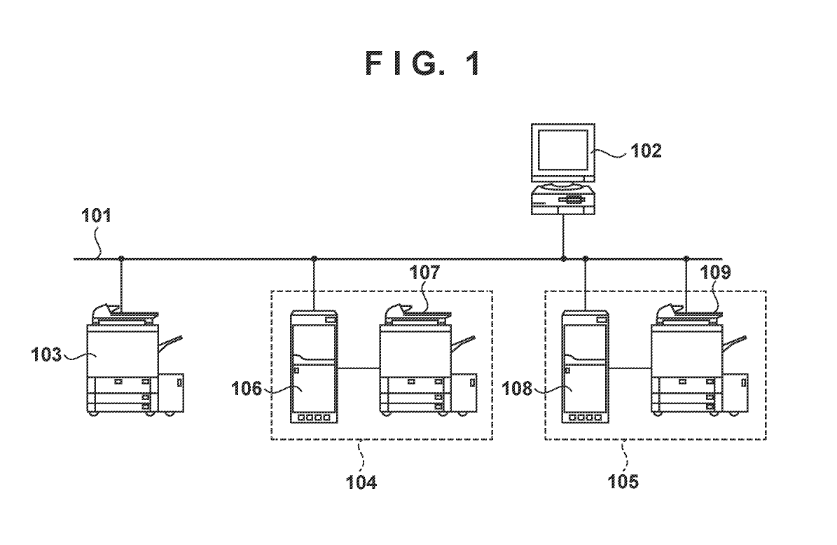

FIG. 1 depicts a view for explaining a configuration of a printing system according to embodiments of the present invention.

In this printing system, printing apparatuses 103-105, and a client PC 102 are connected to a network 101. The printing apparatuses 104 and 105 include RIP controllers 106 and 108, and MFPs (multi function peripheral) 107 and 109 respectively. In the printing apparatus 104, only the RIP controller 106 is connected to the network 101, and in the printing apparatus 105 both the RIP controller 108 and the MFP 109 are connected to the network 101. When the printing is instructed from the client PC 102 by transmitting a print job to any of the printing apparatuses 103-105, printed material is output from the instructed printing apparatus. Note, in the present embodiment, the printing apparatus can be adopted to any of the configurations of reference numerals 103-105 similarly, and explanation is given below with the presumption that the printing apparatus 103 is used for convenience.

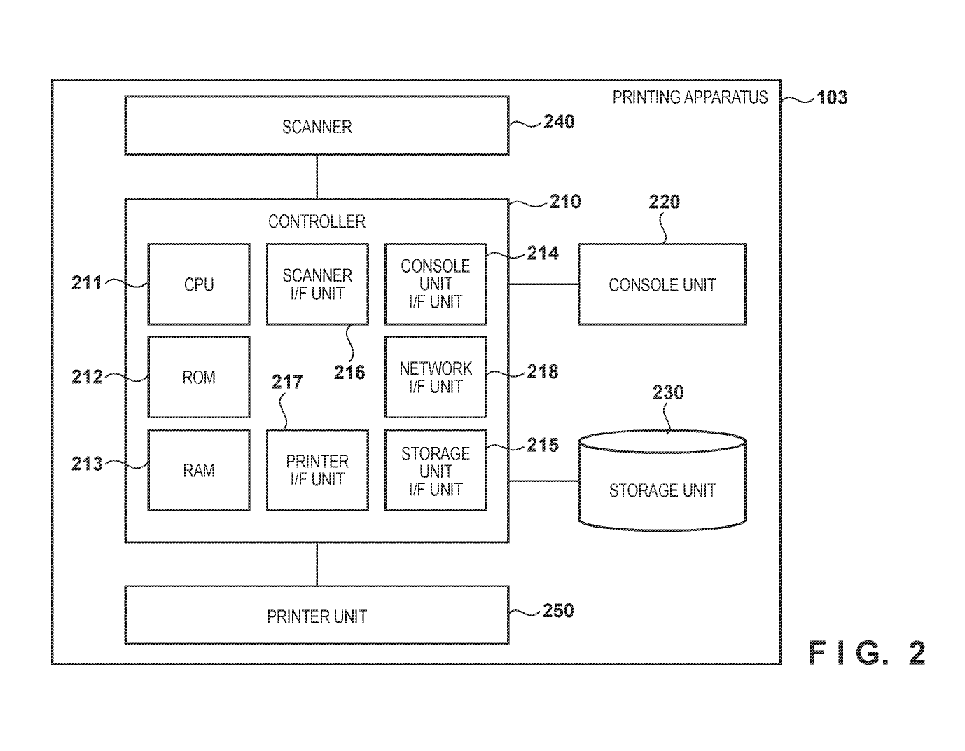

FIG. 2 is a block diagram for explaining a hardware configuration of the printing apparatus 103 according to embodiments.

The printing apparatus 103 has a controller 210, a console unit 220, a storage unit 230, a scanner 240, and a printer unit 250. The controller 210 has a CPU 211, a ROM 212, a RAM 213, a console unit I/F unit 214, a storage unit I/F unit 215, a scanner I/F unit 216, a printer I/F unit 217, and a network I/F unit 218. The controller 210, and each of the console unit 220, the storage unit 230, the scanner 240 and the printer unit 250 are connected via cables (or wiring), and the controller 210 controls operation of each of the units by electrical signals being transmitted over the cables. Also, the console unit I/F unit 214, the storage unit I/F unit 215, the scanner I/F unit 216, and the printer I/F unit 217 each are provided with a driver for transmitting these electrical signals, a receiver chip, a transformer chip for insulation, a connecter, or the like.

Next, explanation will be given for the configuration of the controller 210. The controller 210 functions by the CPU 211 loading a program stored in the ROM 212 or the storage unit 230 into the RAM 213, and executing a part or the whole of the loaded program. The network I/F unit 218 is hardware for connecting with the network 101, and it communicates with the client PC 102, or the like, via the network 101. The console unit 220 has a display unit comprising a touch panel function, and various hardware keys, displays statuses of the printing apparatus 103, operation menus, or the like, to a user, and receives operation instructions from the user. The storage unit 230 has an HDD (hard disk drive), a flash memory, or the like, for example, and stores received print jobs, image data, and various data. The scanner 240 optically scans an original, and generates image data of the original. On the scanner 240 is arranged an automatic original conveyance function (ADF) for stacking a plurality of sheets of originals and automatically conveying these to a reading unit. The printer unit 250 receives print data from the controller 210, and prints based on an instruction of the controller 210. The printer unit 250 has a printer engine that is, for example, ink-jet, electrophotographic, or the like.

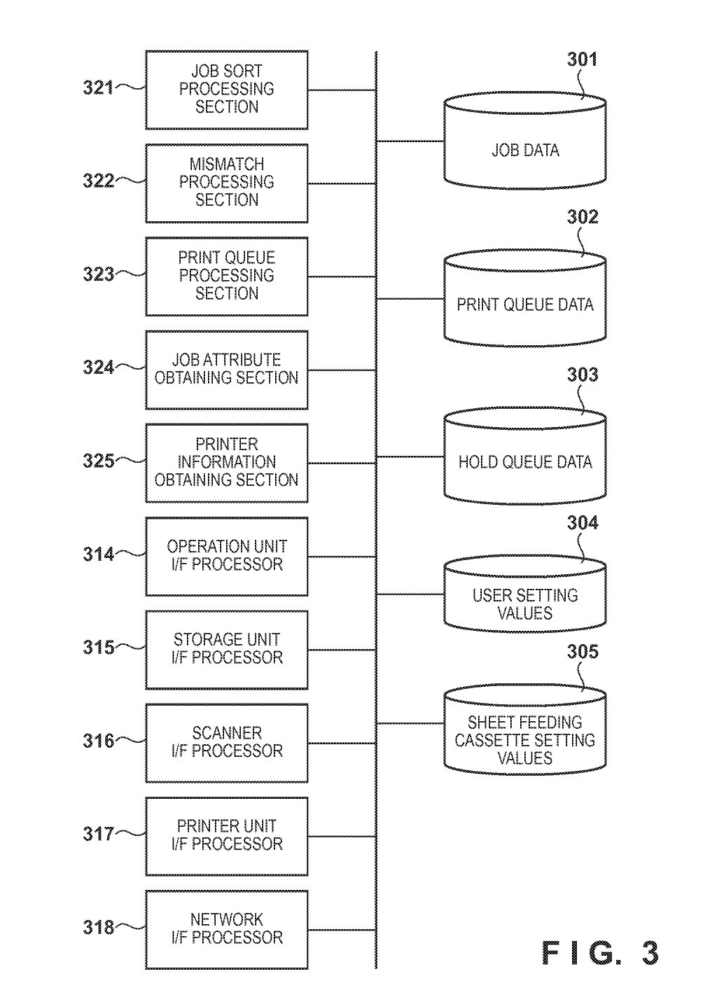

FIG. 3 is a functional block diagram for explaining software that a controller 210 of the printing apparatus 103 according to embodiments executes, and data managed by the controller 210.

Job data 301 is data representing a print job received and stored in the storage unit 230. Print queue data 302 represents print wait data stored in a print queue. Hold queue data 303 represents a print job stored, in a hold queue, as a print job that is not required to be printed immediately, but rather for which printing is initiated upon an instruction of the user, for example. Note, a print job for which printing is reserved is held as the hold queue data 303. User setting values 304 represents various setting values set by the user. Sheet feeding cassette setting values 305 represents sheet size, paper type, or the like, set for each sheet feed source.

An operation unit I/F processor 314, a storage unit I/F processor 315, a scanner I/F processor 316, a printer unit I/F processor 317, and a network I/F processor 318 represent software for controlling corresponding interface units.

A job sort processing section 321 performs sorting of jobs in accordance with a type of the job when a job such as a print job or a copy is received. A mismatch processing section 322 performs processing for confirming whether the sheets necessary for completing a print job are contained in the sheet feed source before initiation of the print job. A print queue processing section 323 performs management of the print queue data 302, or the like. A job attribute obtaining section 324 acquires attributes of a received job. A printer information obtaining section 325 acquires a state of the printer unit 250, or a state of a sheet feed source, or the like. Note, the processing of the above described the processors 314-318 and sections 321-325 is realized by the CPU 211 executing a program deployed into the RAM 213.

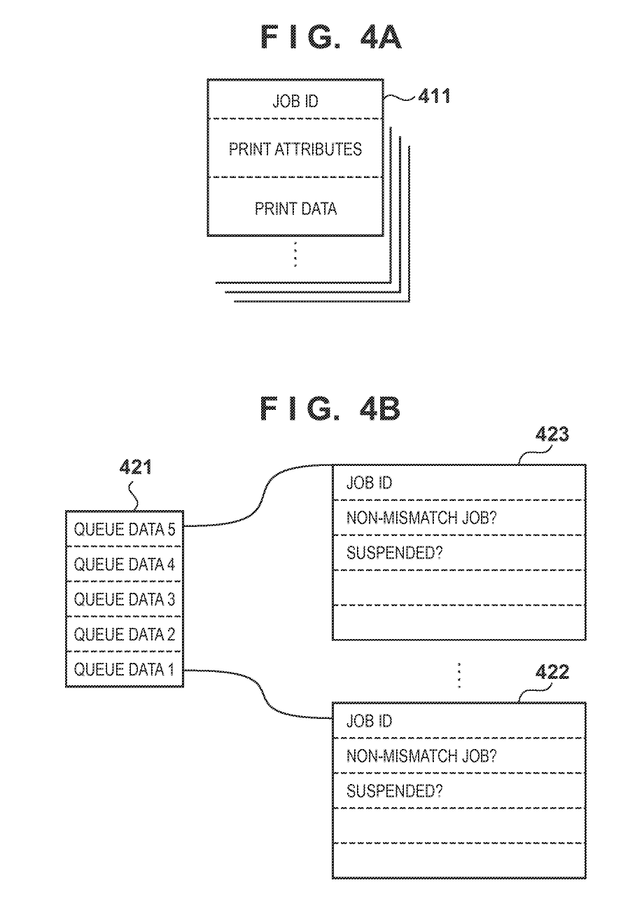

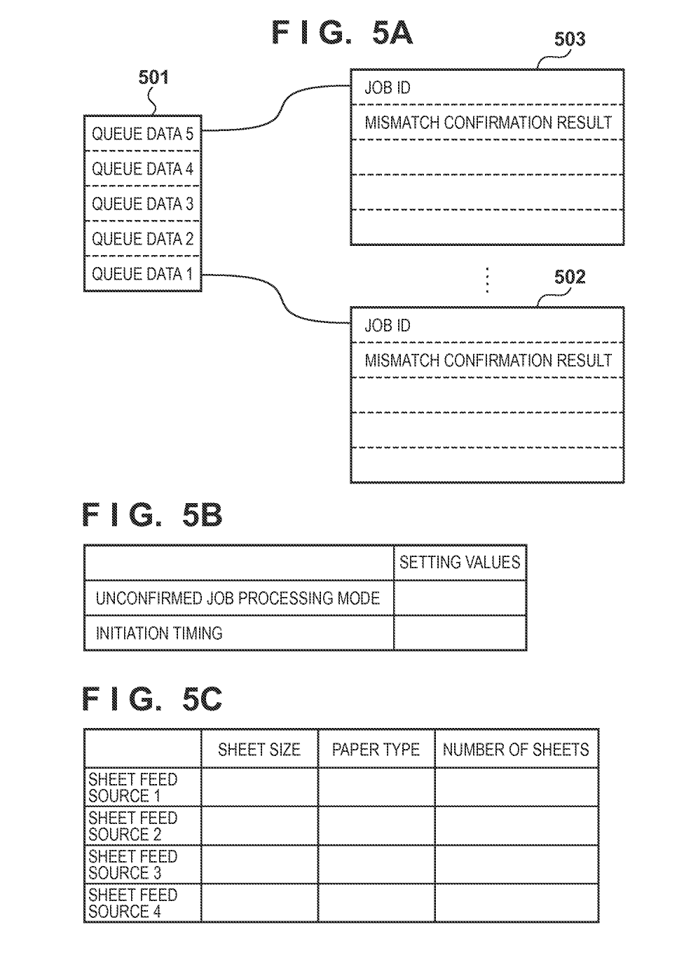

FIGS. 4A and 4B, and FIGS. 5A and 5B respectively depict views for explaining data configurations of the job data 301, the print queue data 302, the hold queue data 303, the user setting values 304, and the sheet feeding cassette setting values 305 according to embodiments.

FIG. 4A depicts a view for illustrating a data configuration of the job data 301. A job input into the printing apparatus 103 and processed has the configuration shown by an entry 411. The entry 411 exists in number equal to the number of jobs input into the printing apparatus 103 and processed. The entry 411 includes a job ID, print attributes, print data, and the like. The job ID is unique identification information (ID) allocated for each job by the later explained job sort processing section 321, and is used in the printing apparatus 103 for identifying a job and specifying a job. A received print job includes print data which is data that describes a size, a paper type (type of sheet), or the like, of the sheets defined in the job, printing attributes describing the number of pages, or the like, and an image to be rendered to the sheets. The job sort processing section 321 stores printing attributes included in the print job and the print data respectively in the printing attributes and the print data of the entry 411.

FIG. 4B depicts a view for illustrating a data configuration of the print queue data 302.

When a print job is input, the print queue processing section 323 manages the print job using a print queue buffer 421. When one print job is input in a state in which there is no print job registered in the print queue buffer 421, the print job is registered as first queue data 1 of the print queue buffer 421. Next, when a print job is input, the print job is queued such that the print job is registered as second queue data 2. The print queue processing section 323 performs print processing from print jobs queued as the first queue data 1. If printing due to one print job completes, the print queue processing section 323 deletes the print job after execution from the print queue buffer 421. With this, the print job queued in the print queue buffer 421 is popped, and the order is shifted up by one. Then, the print queue processing section 323 controls so that next the print job queued as the second queue data 2 is executed. In FIG. 4B, the print queue buffer 421 only has five items of queue data, but an appropriate number items of queue data may be prepared considering a memory capacity, a printing speed, or the like, of the printing apparatus 103.

Print queue job attribute tables 422 and 423 are tables for managing attributes of print jobs registered as each queue data. In FIG. 4B, only print queue job attribute tables corresponding to a print job of the queue data 1 and the queue data 5 are shown, but actually there exist print jobs for each queue data of the print queue buffer 421. The print queue job attribute table 422 includes information of a job ID, “non-mismatch job?”, and “suspended?”. The job ID is the same as the job ID of the entry 411 of FIG. 4A, and is an ID for identifying the print job. The actual print job does not exist in the print queue job attribute table, but rather printing attributes and print data of the corresponding print job are acquired by searching for a print job having the same ID by searching print jobs registered in the entry 411 using the job ID. “non-mismatch job?” represents a result of later explained media mismatch determination processing that the mismatch processing section 322 performs. “suspended?” represents whether or not the job in question is a target of suspend processing that the later explained print queue processing section 323 performs. Details of the items of information are described with respective explanations.

FIG. 5A depicts a view for illustrating a data configuration of the hold queue data 303.

When a print job is input into the hold queue, that print job is managed, as hold queue data, by a hold queue buffer 501. Because the configuration of the hold queue buffer 501 is the same as that of the print queue buffer 421, detailed explanation is omitted.

Hold queue job attribute tables 502 and 503 are used for managing attributes of jobs registered as each hold queue data. The hold queue job attribute tables include information such as the job ID, mismatch confirmation result, or the like. The job ID, similarly to the job ID explained for FIG. 4A, is an ID for identifying each print job. The actual print job does not exist in the hold queue job attribute table, but rather printing attributes and print data of the corresponding entry 411 are acquired by searching for a print job having the same ID by searching in a plurality of entries 411 using the job ID value. Note, in FIG. 5A, only the hold queue job attribute tables 502 and 503 corresponding to the print jobs of the hold queue data 1 and the hold queue data 5 are shown, but actually there exists tables for items of the queue data of the hold queue buffer 501.

FIG. 5B depicts a view for illustrating a data configuration of the user setting values 304.

The user setting values 304 are registered in a user setting table shown in FIG. 5B, and its data configuration includes “unconfirmed job processing mode” and “initiation timing” set on a later explained setting screen.

FIG. 5C depicts a view for illustrating a data configuration of the sheet feeding cassette setting values 305.

The sheet feeding cassette setting values 305 are stored by a sheet feed source setting table shown in FIG. 5C, and for each of the plurality of sheet feed sources that the printing apparatus 103 has, a sheet size, a paper type, and a number of sheets are registered. The sheet size indicates the size of the sheets contained in the corresponding sheet feed source. This is a sheet size detected by a sensor that is arranged in the sheet feed source of the printer unit 250 of the printing apparatus 103, or a sheet size that the user registered via a setting screen (not shown) displayed on the console unit 220. The paper type is a type of sheet contained in the corresponding sheet feed source (a type of paper such as plain paper, thick paper, or the like). This is registered by the user setting via a setting screen (not shown) displayed on the console unit 220. Alternatively, in a case where a sensor arranged in the sheet feed source of the printer unit 250 of the printing apparatus 103 can detect the type of the sheet, the paper type detected by the sensor is registered. The number of sheets indicates the number of remaining sheets contained in the corresponding sheet feed source. Regarding the number of remaining sheets, a stacking height of sheets is detected by a sensor arranged in the sheet feed source of the printer unit 250 of the printing apparatus 103, and registered, for example. Note, in the type of sheet, a value relating to the thickness of the sheet referred to as the grammage is included. Accordingly, the number of remaining sheets may be calculated and stored by dividing the stacking height by the thickness of the sheet. The user normally sets the sheets in the sheet feed source in units of bundles of sheets that are 500 sheets, 1000 sheets or the like. Accordingly, it is possible for the user to register an initial value of the number of sheets via a setting screen (not shown) displayed on the console unit 220, and to calculate accurately the number of remaining sheets by subtracting the number of sheets printed in print jobs from that point.

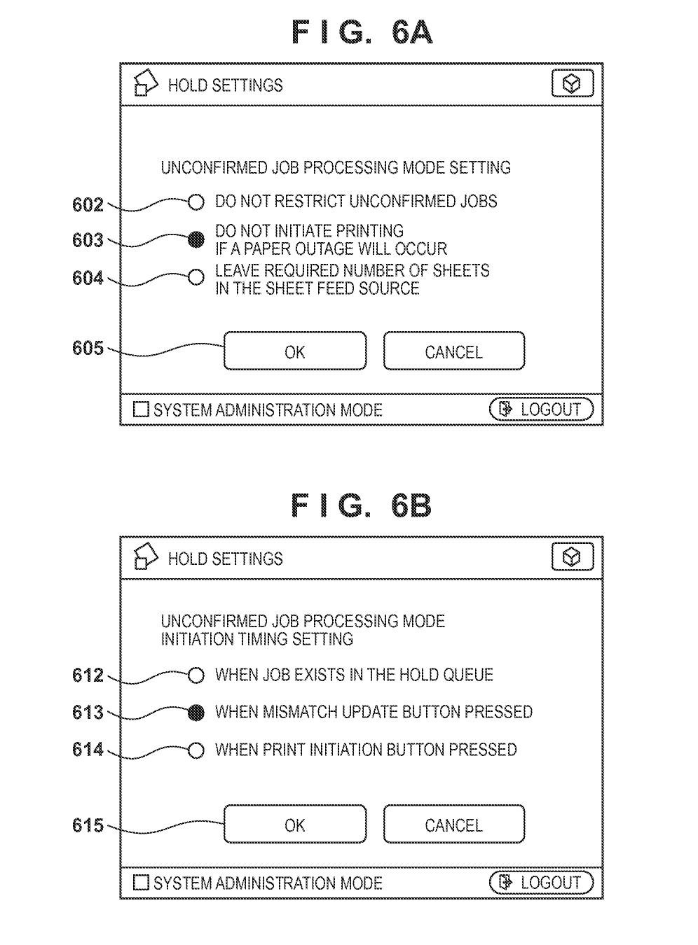

FIG. 6A depicts a view for showing an example of a setting screen for setting an “unconfirmed job” processing mode in this embodiment. This screen is a screen for the user to set what kind of mode should be used in processing represented by a later explained flowchart. This setting screen is displayed on a display unit of the console unit 220, and here buttons 602-604 are displayed for selecting “do not restrict unconfirmed jobs”, “do not initiate printing if a paper outage will occur”, and “leave required number of sheets in the sheet feed source”. Here, when the user selects any of the three buttons and presses an OK button 605, the operation unit I/F processor 314 determines which button is selected from the console unit 220. Then, it registers the setting value of “unconfirmed job processing mode” of the user setting table of the user setting values 304 (FIG. 5B). Note, the processing mode corresponding to the setting value will be explained later with reference to a flowchart.

FIG. 6B depicts a view for showing an example of a screen for setting an initiation timing for executing the processing mode on an unconfirmed job.

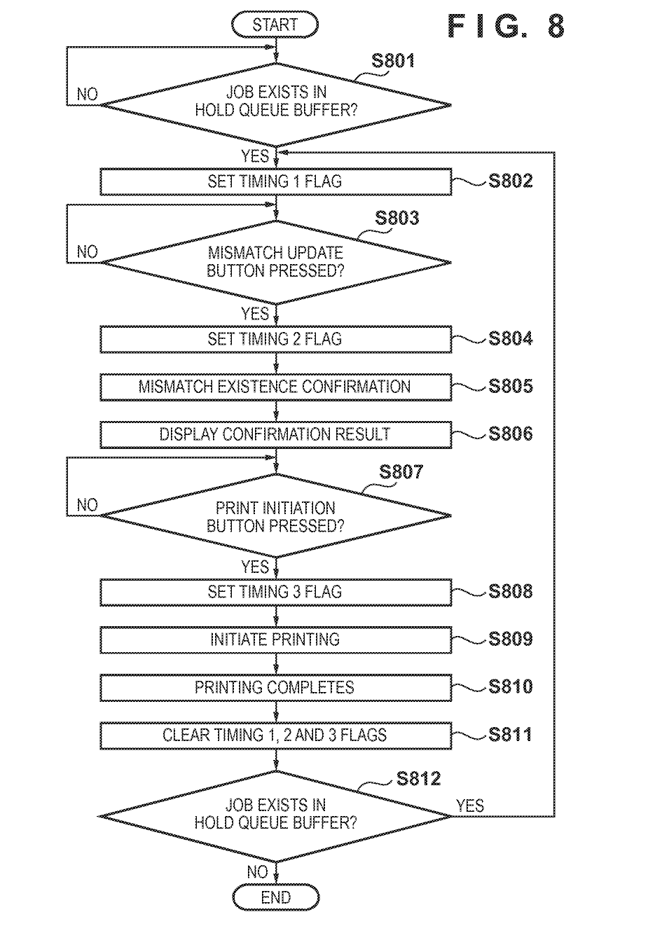

This setting screen is a screen on which the user sets at what timing “unconfirmed job processing mode” set in the screen of FIG. 6A should be initiated in the processing represented by the later explained flowchart of FIG. 8. In the setting screen, the buttons 612-614 for selecting “when job exists in the hold queue”, “when mismatch update button pressed”, and “when print initiation button pressed” are displayed. Here, when the user selects one of the three buttons, and presses the OK button 615, the operation unit I/F processor 314 determines which button was selected from the console unit 220. Then, it registers that in the setting value of “initiation timing” of the user setting table of the user setting values 304 (FIG. 5B). Note, the processing mode corresponding to these setting values will be explained later with reference to a flowchart.

Next, explanation will be given briefly of processing from the print job being input, up until the print job being queued in the print queue buffer 421 or the hold queue buffer 501.

Firstly, the user inputs a print job via the PC 102 or the console unit 220 into the printing apparatus 103. In such a case, if the print job is for initiating printing immediately, the print job is input by specifying the print queue and first stored in the printing apparatus 103. Then, in a case where printing is initiated having confirmed or changed job settings, or the like, the print job is input specifying the hold queue. These kinds of instruction values of print jobs by the user are stored as job attributes.

When a print job is input, first the job sort processing section 321 receives the print job, generates a unique job ID, and allocates the job ID to the print job. The job sort processing section 321 generates one entry 411 in the job data 301 for one print job, and registers the generated job ID in the job ID of the entry 411. Furthermore, the printing attributes of the job and the print data are registered in the printing attributes of the entry 411 and the print data of the entry 411 respectively from the received print job data. Next, the previously described instruction values of the queue are read, and if the instruction value indicates a print queue, the print job is queued as queue data in the print queue buffer 421 (FIG. 4B), and if the instruction value indicates a hold queue, the print job is stacked as hold queue data in the hold queue buffer 501 (FIG. 5A). The job sort processing section 321 generates a print queue job attribute table 422 or a hold queue job attribute table 502 shown in FIG. 4B and FIG. 5A for one print job in a case of stacking in either of the buffers. Then, the job ID is registered in the job ID of the tables. Note, because stacking print jobs in the print queue buffer 421 or the hold queue buffer 501 due to the input of these kinds of print jobs is a well known processing approach, this flowchart is omitted.

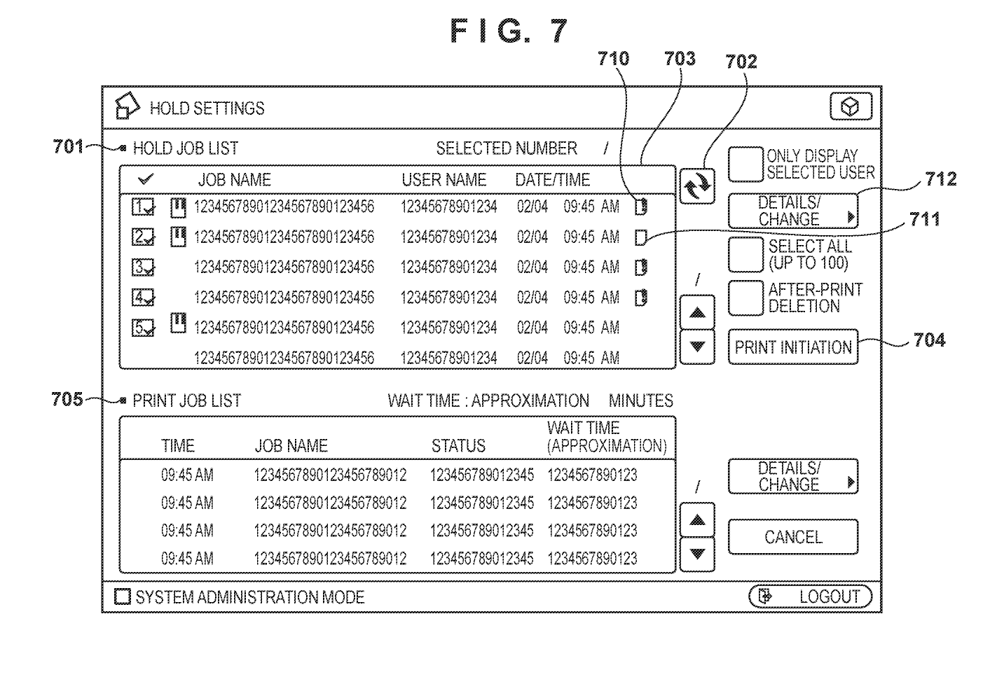

FIG. 7 depicts a view for illustrating an example of a user operation screen of a media mismatch determination function according to embodiments.

This operation screen has a hold job list 701, and here a list of print jobs stacked in the hold queue buffer 501 is displayed in order of the queues. The user confirms whether or not a mismatch exists by selecting a print job that he or she wishes to print from the hold job list 701, and pressing a mismatch update button 702. The result is displayed in an icon in the right side of each line of a result icon display area 703 of the hold job list 701. From the type of these icons, either “no mismatch”, “no mismatch but no remaining sheets” or “mismatch” can be identified. The user instructs print initiation by selecting a print job for which there is no mismatch based on icons and pressing a print initiation button 704. A print job, for which printing is thus initiated, is displayed on a print job list 705. The print jobs displayed on the print job list 705 are executed and printing is performed when the turn of the print job comes up, and when the printing completes, the print job is deleted from the print job list 705.

In FIG. 7, numeral 710 indicates an icon for a case of “mismatch”, and numeral 711 indicates an icon for a case of “no mismatch but no remaining sheets”. When neither of these icons is displayed, that indicates “no mismatch”.

FIG. 8 is a flowchart for describing processing that the mismatch processing section 322 performs corresponding to a print job held in the hold queue buffer 501 in the printing apparatus according to a first embodiment. Note, the processing is executed by a program that executes the processing installed in the ROM 212 or the storage unit 230, being deployed into the RAM 213 upon execution, and executed under the control of the CPU 211. In the explanation below, explanation is given having the CPU 211 execute the processing.

When the processing is initiated, the CPU 211, in step S801, determines whether or not job data is held as hold queue data of the hold queue buffer 501 shown in FIG. 5A, for example. When the CPU 211 determines that job data is not held, executing step S801 is repeated, and when the CPU 211 determines that job data is held, the processing proceeds to step S802, and the CPU 211 sets a “timing 1 flag” in the RAM 213. Note, in step S802, the CPU 211 displays the hold job list as shown in FIG. 7 on the console unit 220. Next, the processing proceeds to step S803, and the CPU 211 determines whether or not the user pressed the mismatch update button 702 via the console unit 220. When the result of this determination is that it is determined that the mismatch update button 702 is pressed, the processing proceeds to step S804, and the CPU 211 sets “timing 2 flag” in the RAM 213. Next, the processing proceeds to step S805, and the CPU 211 confirms whether or not a mismatch exists, and this confirmation result is displayed on the console unit 220 as illustrated in FIG. 7, for example. The operation of these two steps is as follows.

The CPU 211 specifies which print job the user selected out of the hold job list 701 prior to the mismatch update button 702 being pressed (all selected print jobs in a case where a plurality of print jobs are selected). As previously explained, because the print jobs are displayed in the hold job list 701 in the order that the print jobs are held in the hold queue buffer 501, it can be confirmed easily which the print job the hold queue data that the user selected corresponds to. Next, the job ID of the print job that the user selected is acquired by referencing the hold queue job attribute table (FIG. 5A) of the hold queue data of the hold queue buffer 501 in which the selected print job is held. Next, based on this job ID, a print job matching the job ID from out of the entry 411 is searched, and the printing attributes is acquired. Then, in step S805, the CPU 211 calculates the size of the sheets that the print job uses, the paper type, and the number of sheets based on the printing attributes. Then, the CPU 211, compares this calculation result and the values stored in the sheet feed source setting table of FIG. 5C, and determines whether the combination of the size and the paper type of the sheets that the print job uses exists in any of the sheet feed sources of the printing apparatus 103. Here, in a case where it is determined that such a combination exists, the CPU 211, in step S806, does not display the icon on the icon display area 703 of FIG. 7. Because of this, the user can determine that the selected print job is executable using a sheet feed source of the printing apparatus 103.

Note, the CPU 211 may set the sheet feed source for executing the print job automatically to an applicable sheet feed source based on the result of the determination, or configuration may be taken such that all of the sheet feed sources applicable are displayed in the operation screen, and the user may be allowed to select the sheet feed source of his or her choice.

Meanwhile, when as the result of the confirmation of step S805, a sheet feed source containing sheets for which the size of the sheets and the paper type matches exists, but it is determined that there are no remaining sheets in the sheet feed source, i.e. there is no number of remaining sheets of the sheet feed source setting table of the sheet feed source. In such a case, the CPU 211, in step S806, displays an out of paper icon 711 on the icon display area 703 corresponding to the held print job. Also, in a case where it is determined that there is no combination of the size and the type of sheets that the print job uses in the sheet feed source as the result of the confirmation of step S805, the CPU 211, in step S806, displays the mismatch icon 710 on the icon display area 703 corresponding to the held print job. The icon 710 displayed in FIG. 7 indicates the mismatch icon.

Next, the processing proceeds to step S807, and the CPU 211 determines whether or not the print initiation button 704 of the operation screen shown in FIG. 7 is pressed. When it is determined that the print initiation button 704 is pressed, the processing proceeds to step S808, and the CPU 211 sets “timing 3 flag” in the RAM 213. Then, in step S809, printing is initiated.

The processing of step S809 is as follows. The CPU 211, deletes the held print job selected by the user from the hold queue buffer 501, and registers it in the print queue buffer 421 of FIG. 4B. Here, because the hold queue data corresponding to the selected held print job is deleted from the hold queue buffer 501, the corresponding print job is deleted from the hold job list 701 of the operation screen of FIG. 7, and the print job is registered in the print queue buffer 421. With this, that print job is displayed in the print job list 705 of the operation screen of FIG. 7. Here, the CPU 211 sets the attribute “non-mismatch job?” of the print queue job attribute table 422 to “non-mismatch job”. Note, in a case where an unconfirmed job is stacked in the print queue buffer 421 here, the attribute “non-mismatch job?” of the print queue job attribute table 422 is set to “unconfirmed job”. Then, in step S809, the CPU 211 prints by executing the print job registered in the print queue buffer 421. Then, the processing proceeds to step S810 when the CPU 211 completes the print job, and in step S811, the CPU 211 clears the “timing 1 flag”, “timing 2 flag”, and “timing 3 flag” stored in the RAM 213. Next, the processing proceeds to step S812, and the CPU 211 determines whether or not a print job exists in the hold queue buffer 501. In a case where it is determined that a print job does exist, the processing proceeds to step S802, and the previously described processing is repeated. When the print jobs in the hold queue buffer 501 run out, the processing completes.

In this way, by virtue of the processing shown in FIG. 8, in a case where a print job is held in the hold queue buffer 501, a list of hold jobs is displayed on the console unit 220, and the user is able to select a desired the print job from the list and print. Here it can be distinguished whether or not there is a sheet feed source containing the sheets that will be used for executing the print job that the user selected, and whether or not the print job can be completed using the sheets of the sheet feed source.

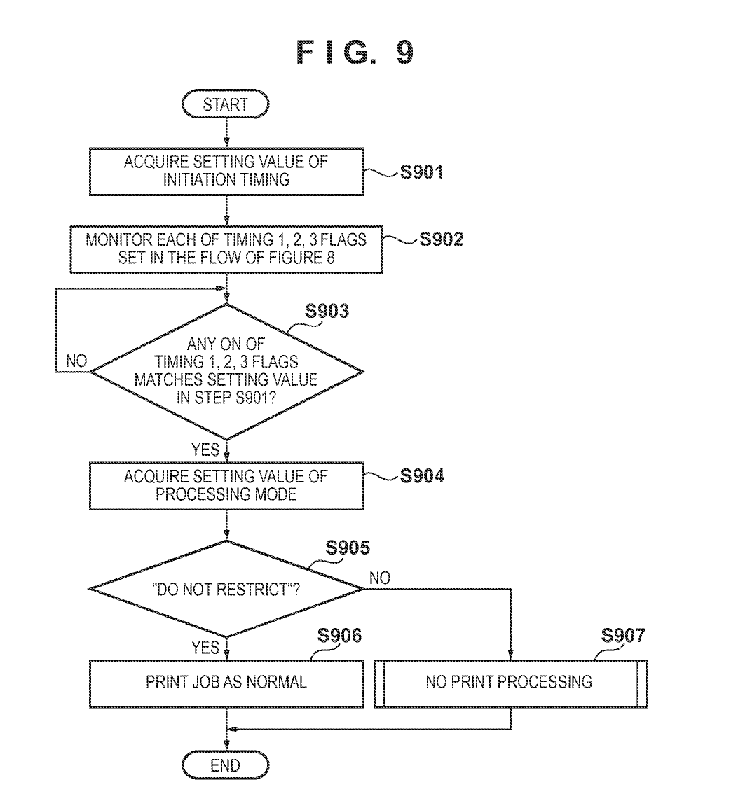

FIG. 9 is a flowchart for describing processing in a case where a media mismatch occurs in the printing apparatus 103 according to the first embodiment. Note, the processing is executed by a program that executes the processing installed in the ROM 212 or the storage unit 230, being deployed into the RAM 213 upon execution, and executed under the control of the CPU 211. In the explanation below, explanation is given having the CPU 211 execute the processing.

Firstly, in step S901, the CPU 211 acquires a setting value of an initiation timing of the user setting table (FIG. 5B) of the user setting values 304. Next, the processing proceeds to step S902, and the CPU 211 monitors each of the flags for the timings 1, 2 and 3 set in the processing shown by the flowchart of the previously described FIG. 8. Next, the processing proceeds to step S903, and the CPU 211 determines whether or not each flag for the timings 1, 2 and 3 and the setting value acquired in step S901 match, and repeatedly executes the processing of step S903 until they are the same. When it is determined that the values are the same in step S903, the processing proceeds to step S904. The processing of step S903 is something that is for executing an unconfirmed job processing mode from step S904 at a timing corresponding to the timing at which the unconfirmed job processing mode set in FIG. 6B is initiated.

In step S904, the CPU 211 acquires a setting value of the unconfirmed job processing mode of the user setting table (FIG. 5B) of the user setting values 304. Then, the processing proceeds to step S905 and the CPU 211 determines whether or not the setting value acquired in step S904 is “do not restrict unconfirmed jobs” (refer to FIG. 6A). If the setting value is “do not restrict unconfirmed jobs”, the processing proceeds to step S906, and the CPU 211 prints the unconfirmed job as normal and the processing completes. On the other hand, if the setting is “do not initiate printing if a paper outage will occur” or “leave required number of sheets in the sheet feed source”, the processing proceeds to step S907, and the CPU 211 performs processing for when not to print, and the processing completes.

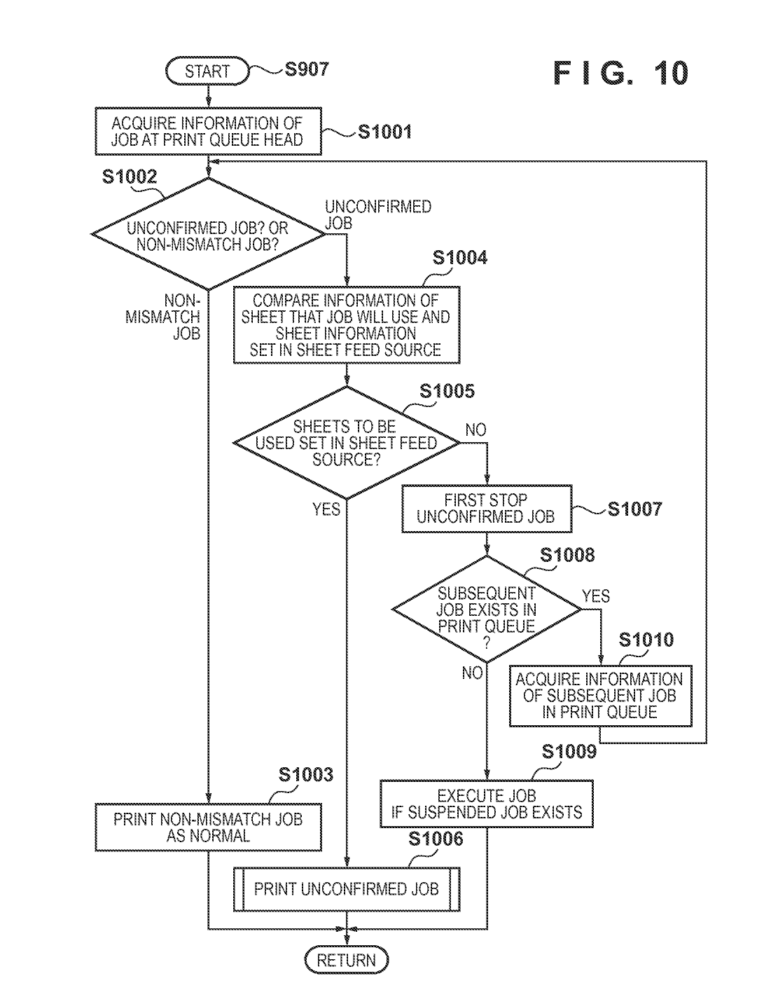

Note, the explanation of the processing of step S907 will be explained later with reference to the flowchart FIG. 10. Also, the processing of step S906, as explained with the processing mode of the print job of the print queue buffer 421 of FIG. 4B is the processing for printing the job in queue data 1 itself.

FIG. 10 is a flowchart for describing processing in a case where in step S907 of FIG. 9 printing is not performed.

Firstly, in step S1001, the CPU 211 acquires a value of “non-mismatch job?” of the print queue job attribute table 422 of the print job stacked at the head of the print queue buffer 421 (normally queue data 1). Next, the processing proceeds to step S1002 and the CPU 211 determine whether that acquired value is “non-mismatch job” or “unconfirmed job”. If it is determined that the value is “non-mismatch job”, the processing proceeds to step S1003, and the CPU 211 executes the printing as normal, and returns.

On the other hand, when, in step S1002, it is determined that the value is “unconfirmed job”, the processing proceeds to step S1004. In step S1004, the CPU 211 searches in the multiple entries 411, and searches for a print job having the same job ID in the value of the job ID of the print queue job attribute table 422, and acquires printing attributes and print data of that print job from the corresponding entry 411. Explaining this processing with FIG. 3, the mismatch processing section 322 and the print queue processing section 323 calculate the sheet size, paper type and the number of sheets that the print job will use from the printing attributes. In step S1004, the CPU 211 compares these calculation results and the setting values of each sheet feed source held in the sheet feed source setting table of FIG. 5C. As a result of this comparison, the CPU 211 determines in step S1005 if the combination of the size and the type of the sheets that the print job will use exists in the sheet feed source setting table, and if the number of sheets necessary for executing the print job exist. In a case where it is determined in step S1005 that these do exist as the result of this determination, because a paper outage will not occur, the processing proceeds to step S1006, and the CPU 211 prints the unconfirmed job, and the processing completes.

On the other hand, in a case where it is determined that a corresponding sheet feed source, or the sheets do not exist in step S1005, the processing proceeds to step S1007, and the CPU 211 first stops the unconfirmed job. Then, the CPU 211 writes a value indicating being suspended in the “suspended?” attribute of the print queue job attribute table 422 of FIG. 4B. Note, the “suspended?” attribute of the print queue job attribute table 422 holds a value indicating not being suspended as the default value, and in a case where step S1007 is not executed, the value will continue to be that indicating not being suspended. Next, the processing proceeds to step S1008, and the CPU 211 determines whether or not there is a print job stored in the next queue data of the print queue buffer 421. When it is determined that there is a subsequent print job, the processing proceeds to step S1010, and the value of “non-mismatch job?” of the print queue job attribute table 422 of the subsequent print job is acquired. Next, the CPU 211 moves the processing to step S1002.

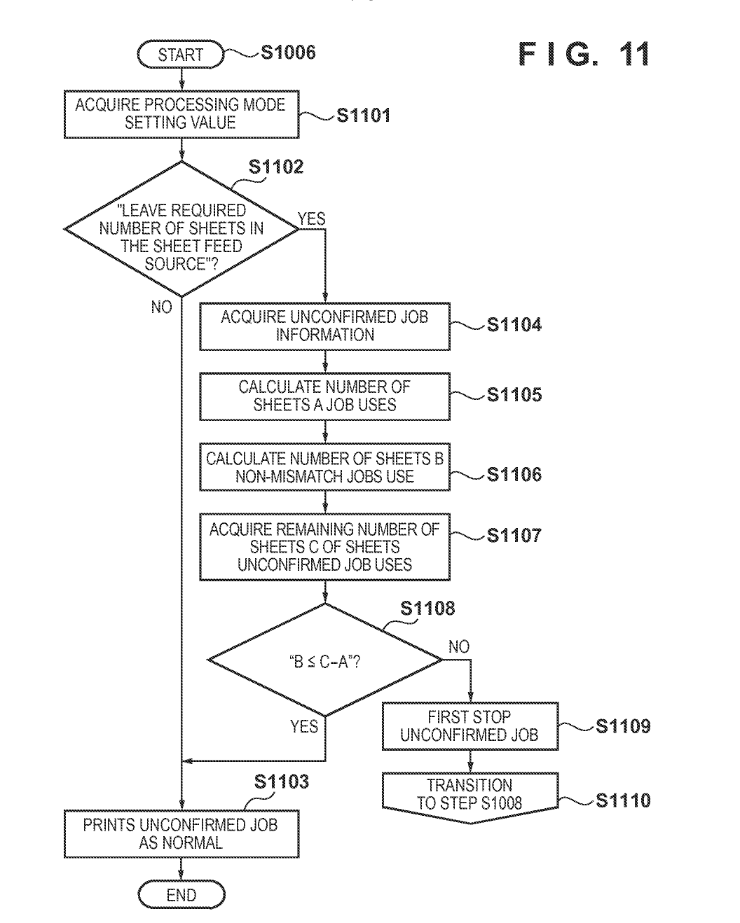

On the other hand, when it is determined that there is no subsequent print job in step S1008, the processing transitions to step S1009. When the processing transitions to step S1009, the state is such that only the print job first stopped in step S1007 is stored in the print queue buffer 421. Here, the CPU 211 confirms that the “suspended?” attribute of the print queue job attribute table 422 is a value indicating being suspended, and prints by executing the print job. Note, the processing for printing an unconfirmed job of step S1006 is explained with reference to the flowchart of FIG. 11.

According to the flowchart shown in FIG. 10, in a case of an unconfirmed job out of the print jobs stored in the print queue buffer 421 and the sheets that this unconfirmed job uses not being contained in any of the sheet feed sources, the execution of the print job is first stopped. Then, after all of the other print jobs have completed, the printing for the print job that was+ first stopped is executed under the condition that the user sets the sheets that the first stopped print job uses in a sheet feed source. With this, a non-mismatch job can be printed without an error occurring.

FIG. 11 is a flowchart for describing print processing of an unconfirmed job of step S1006 of FIG. 10.

Firstly, in step S1101, the CPU 211, similarly to step S904 of FIG. 9, acquires a setting value of the processing mode of an unconfirmed job of the user setting table (FIG. 5B) in the user setting values 304. Next, the processing proceeds to step S1102, and the CPU 211 determines whether or not the setting value acquired in step S1101 is “leave required number of sheets in the sheet feed source” (FIG. 6A). If the setting value is not “leave required number of sheets in the sheet feed source”, the CPU 211 moves the processing to step S1103, prints the unconfirmed job as normal, and the processing completes.

On the other hand, when the CPU 211 determines that the setting value is “leave required number of sheets in the sheet feed source” in step S1102, it moves the processing to step S1104. In step S1104, the CPU 211, similarly to previously explained step S1004, searches in the multiple entries 411 and searches for a print job having the same job ID in the value of the job ID of the print queue job attribute table 422. Then, the CPU 211 acquires the printing attributes and the print data of the entry 411 corresponding to the job ID. Then, the processing proceeds to step S1105 and the CPU 211 calculates the number of sheets (A) that the print job uses for each combination of sheet size and paper type from these printing attributes. Next, the processing proceeds to step S1106, and the CPU 211 acquires the value of “non-mismatch job?” of the print queue job attribute table 422, and searches all of the non-mismatch job in the print jobs stored in the print queue buffer 421. Then, based on their job IDs, the CPU 211 acquires the printing attributes and the print data, and based on these calculates the number of sheets (B) used in non-mismatch jobs for each combination of sheet size and paper type. Next, the processing proceeds to step S1107, and the CPU 211 acquires the value of the sheet feed source setting table, and calculates the remaining number of sheets (C) of the sheets that the unconfirmed job uses for each combination of sheet size and paper type.

When, in this way, each of the number of sheets A, B and C are calculated for each combination of sheet size and paper type, the processing proceeds to step S1108, and the CPU 211 determines whether or not (C−A)>=B. Here, when it is determined that (C−A)>=B, the processing proceeds to step S1103, and the CPU 211 processes the unconfirmed job as normal. On the other hand, in a case where (C−A)<B, the processing transitions to step S1109, and the CPU 211, similarly to previously explained step S1007, first stops the unconfirmed job. Then, the CPU 211 writes a value indicating being suspended in the “suspended?” attribute of the print queue job attribute table 422. Then, in step S1110, the CPU 211 moves the processing to step S1008 of FIG. 10.

By virtue of the processing shown in FIG. 11, even in a case of an unconfirmed job, out of the print jobs stored in the print queue buffer 421, and the sheets that this unconfirmed job uses being set in the sheet feed source, control is taken as follows. Specifically, print processing for a print job, that would not leave, in a sheet feed source, sheets planned for a non-mismatch job to use, is first stopped, and after the other print jobs have completed, the suspended print job is executed. With this, a non-mismatch print job can be printed without an error occurring caused by a sheet deficiency, or the sheet size, or the paper type being different.

### Second Embodiment

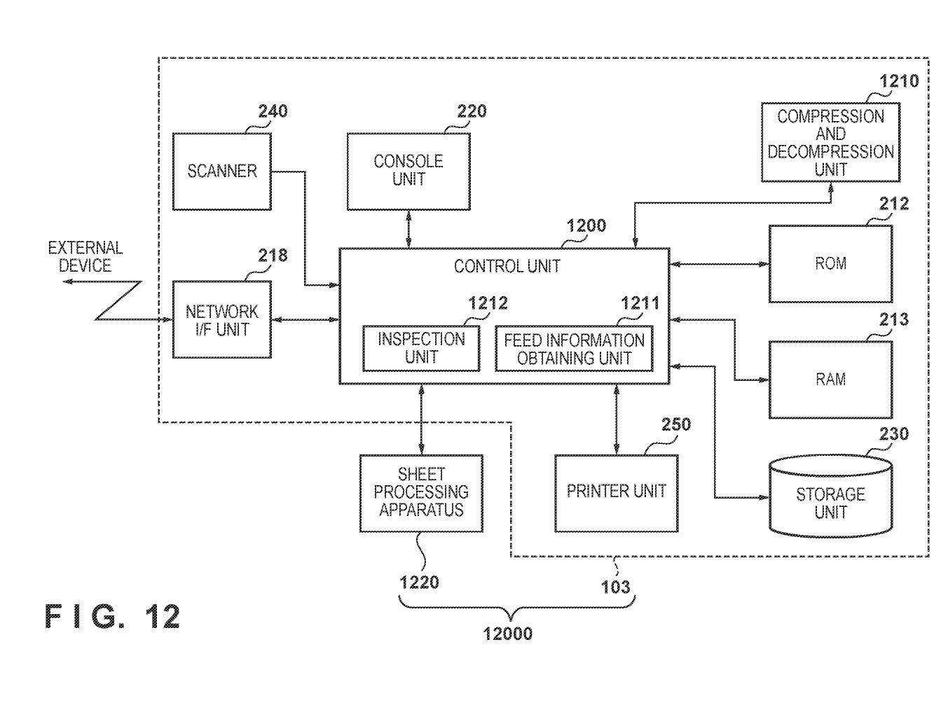

FIG. 12 is a block diagram for showing a configuration of a printing system according to the second embodiment of the present invention.

This printing system 12000 comprises the printing apparatus 103 which is a part surrounded by dashed lines in the figure, and a sheet processing apparatus 1220. Note, in the second embodiment, explanation will be given with the example of the printing apparatus according to the previously described first embodiment as the printing apparatus 103. So, constituent elements common with the previously described FIG. 2 are shown with the same reference numerals, and their explanation will be omitted. However, the printing apparatus 103 may be a printing apparatus of a type having only a printing function.

Configuration may be taken so that the printing system 12000 is able to execute sheet processing corresponding to a sheet printed by the printing apparatus 103 with the sheet processing apparatus 1220 connected to the printing apparatus 103. However, it is possible to configure the printing system 12000 with only the printing apparatus 103 without connecting the sheet processing apparatus 1220. The sheet processing apparatus 1220 is configured communicatively with the printing apparatus 103, and is able to execute various sheet processing such as stapling, hole punching, folding processing, bookbinding printing, or the like upon receiving an instruction from the printing apparatus 103.

A control unit 1200 has the CPU 211 as illustrated in FIG. 2, and this control comprehensively processing, operation, or the like, of various units that the printing system 12000 comprises. In other words, the CPU 211 controls operation of the printing apparatus 103, and the sheet processing apparatus 1220 connected to the printing apparatus 103. The ROM 212 stores various computer programs executed by the CPU 211 of the control unit 1200. For example, the ROM 212 stores programs for causing the control unit 1200 to execute various processing of a later explained flowchart, a display control program necessary for displaying various later explained setting screens on the console unit 220, or the like. Also, the ROM 212 stores programs for executing operation for the control unit 1200 interpreting PDL code data received from the PC, and loading it into raster image data. A compression and decompression unit (CODEC) 1210 performs compression and decompression of image data, or the like, stored in the RAM 213, or the storage unit 230, by various compression formats such as JBIG, JPEG, or the like.

Also, the control unit 1200 is able to display, on a touch panel unit of the console unit 220, a list of PDL code data managed/stored as jobs in the storage unit 230. In the second embodiment, jobs (PDL code data) in this state are referred to as hold jobs. The control unit 1200, based on an instruction of an operator made interactively via the touch panel unit of the console unit 220 with respect to this display, is able to interpret the jobs stored in the storage unit 230, and to print with the printer unit 250. Also, the control unit 1200 has a feed information obtaining unit 1211 for acquiring information of what kind of sheet settings are made, or to what extent sheets are mounted for a feed tray (sheet feed source) that the printer unit 250 comprises. Furthermore, the control unit 1200 comprises an inspection unit 1212 for determining whether or not sufficient sheets are contained in the feed tray to complete a target print job based on print medium information used by the print job, and paper feed information acquired by the feed information obtaining unit 1211. Here, when the inspection unit 1212 executes the print job as is, without the sheets necessary for printing being set in the printing apparatus 103, for example, the inspection unit 1212 determines whether or not a state such as one in which the printing is stopped by a paper outage error is entered.

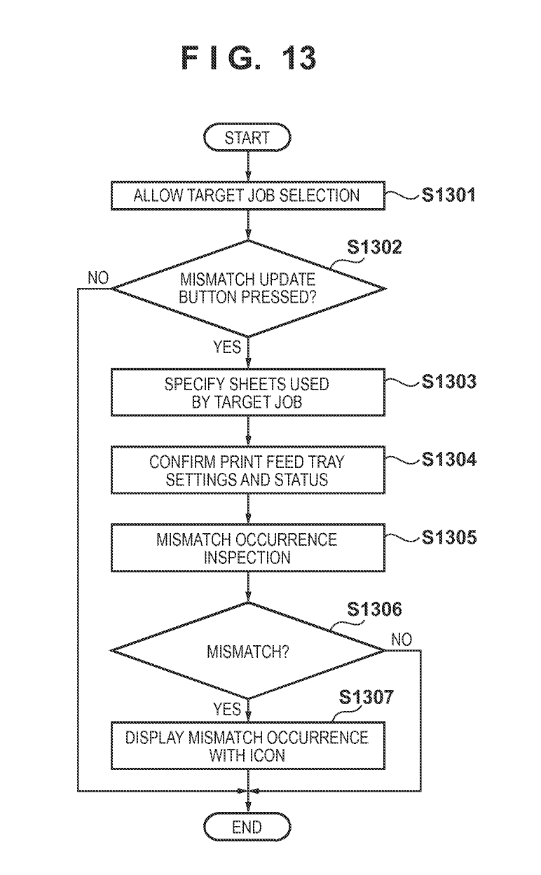

FIG. 13 is a flowchart for describing processing by the printing apparatus 103 according to the second embodiment. Here, explanation will be given for an example in which, from the list 701 of hold jobs shown in the previously described FIG. 7, the user selects a desired print job causing it to print.

Firstly, in step S1301, the control unit 1200 displays a screen such as FIG. 7 on the touch panel unit of the console unit 220. In this way, by the hold jobs being displayed in a list as the list 701, the control unit 1200 prompts the user for the selection of a job. Here, when the touch panel unit is operated by the user, and a desired print job is selected by the user, the control unit 1200 controls the console unit 220 so as to highlight the selected target print job. With this, the user is able to distinguish which is the selected print job. Next, the processing proceeds to step S1302, and the control unit 1200 determines whether or not the mismatch update button 702 is pressed, and when it is not pressed, the process is terminated. On the other hand, when it is determined in step S1302 that the mismatch update button 702 is pressed, the processing proceeds to step S1303, and the control unit 1200 analyzes the print job selected in step S1301, and that print job specifies the sheets planned to be used in the printing. The processing proceeds to step S1304, the control unit 1200, via the feed information obtaining unit 1211, acquires setting information and status of the feed trays that the printing apparatus 103 has. Next, the processing proceeds to step S1305, and the control unit 1200, based on the information of the sheets specified in step S1303 and the setting information of the feed tray acquired in step S1304, determines whether or not a mismatch occurs for the print job that the user selected with the inspection unit 1212. Then, in step S1306, when the control unit 1200 determines that a mismatch occurred, the processing proceeds to step S1307, and the control unit 1200 displays the mismatch icon 710 as illustrated in FIG. 7, and the processing completes.

With this, the user is able to confirm whether or not a mismatch of sheets occurs for the selected print job. Note, by pressing the details/change button 712, the user is able to perform operation for keeping track of the content of mismatches or eliminating the mismatch of sheets.

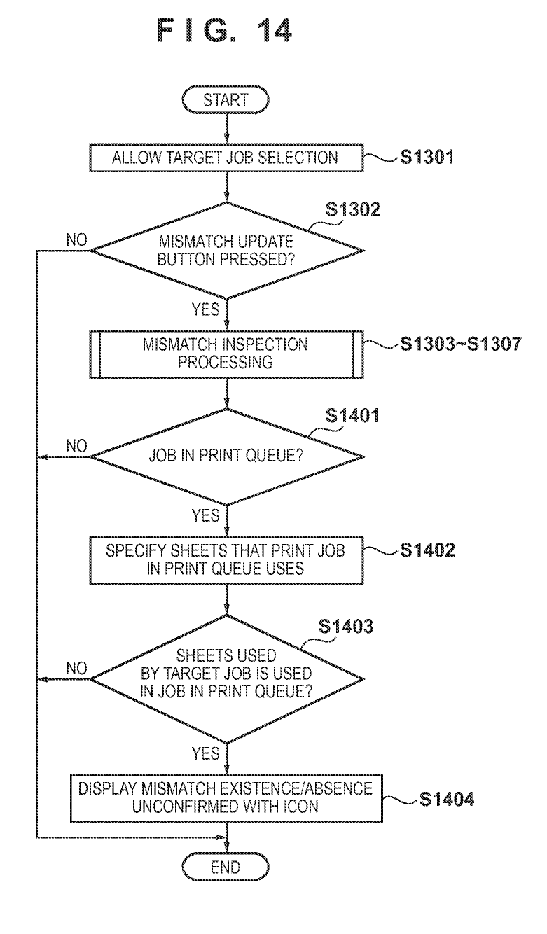

FIG. 14 is a flowchart for describing processing by the printing apparatus 103 which is executed continuing from the processing shown in the flowchart of FIG. 13 in the second embodiment. Note, in this flowchart, the processing from step S1301 to step S1307 is the same as the processing content explained with FIG. 13, and so this explanation is omitted.

When the mismatch inspection processing (step S1303 to step S1307) completes, the processing proceeds to step S1401 and the control unit 1200 determines whether or not there is a print job in the print queue buffer 421. The print queue buffer 421 is a wait queue including print jobs input into the printing apparatus 103 as print initiations. Then, in a case where there is a print job in the print queue buffer 421, the processing proceeds to step S1402, and the control unit 1200 displays in a list the content of the print queue buffer 421 on the touch panel unit of the console unit 220 as in the print job list 705 of FIG. 7. Note, in step S1401, in a case where it is determined that there is no print job in the print queue buffer 421, the control unit 1200 completes the processing.

In a case where it is determined that there is a print job in the print queue buffer 421, the processing proceeds to step S1402, and the control unit 1200 interprets the print job in the print queue buffer 421, and specifies the sheets that the print job uses. Next, the processing proceeds to step S1403, and the control unit 1200 determines whether or not the sheets that the print job selected in step S1301 uses are included in the sheets used in the print job specified in step S1402. In a case where it is determined in step S1403 that they are not included, the control unit 1200 completes the processing.

On the other hand, in a case where it is determined that in step S1403 they are included, the processing proceeds to step S1404, and the control unit 1200 determines that the existence or absence of a mismatch is unconfirmed regarding the sheets, and displays something to that effect with an icon. Here, in the flowchart of FIG. 13, it is determined that the sheets that the print job that the user selected from the hold job list is to use are contained in a feed unit of the printing apparatus 103 and a media mismatch does not occur. However, when the sheets that the print job uses for which it is determined that a media mismatch will not occur are used by a print job of the print queue buffer 421, there is a possibility that the remaining paper amount will be insufficient at the point in time when the held print job is initiated. Accordingly, in such a case, it is determined that the existence or absence of a media mismatch is unconfirmed for the held print job.

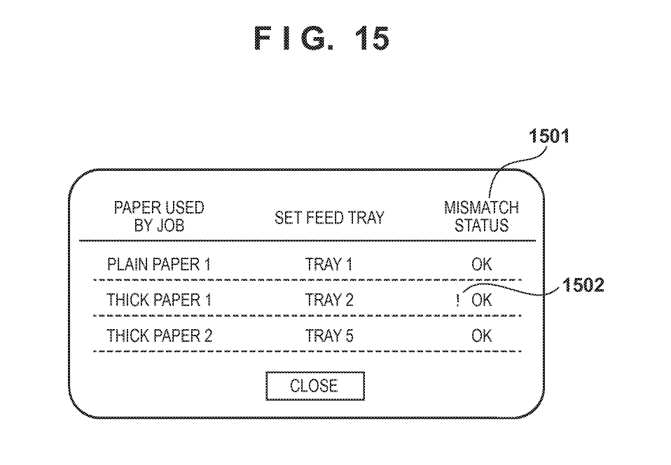

FIG. 15 depicts a view for showing an example of a screen that the control unit 1200 in step S1404 of FIG. 14 displays.

Here, FIG. 15 represents an example of a screen that the control unit 1200 displays on the touch panel unit of the console unit 220 when the details/change button 712 is pressed by the user in order to understand the detailed content of mismatches. For example, the sheets used by target print jobs are plain paper, thick paper 1, and thick paper 2, and all are set in feed trays that the printing apparatus 103 comprises. In such a case, the control unit 1200 performs the processing of step S1301 through step S1307, and determines that for these sheets there is no mismatch (no problem). Then, “OK” is displayed in the mismatch status 1501 item. However, in a case where it is determined that the thick paper 1 is used by a print job of the print queue buffer 421, the processing of step S1401 through step S1403 of FIG. 14 having been performed, the control unit 1200 displays something to that effect in a form such as warning mark 1502 for the item of the mismatch status 1501. With this, the print jobs for which there is the possibility that a mismatch will occur due to the print processing after that even if there is no problem at the timing that the mismatch inspection is performed can be accurately informed to the user.

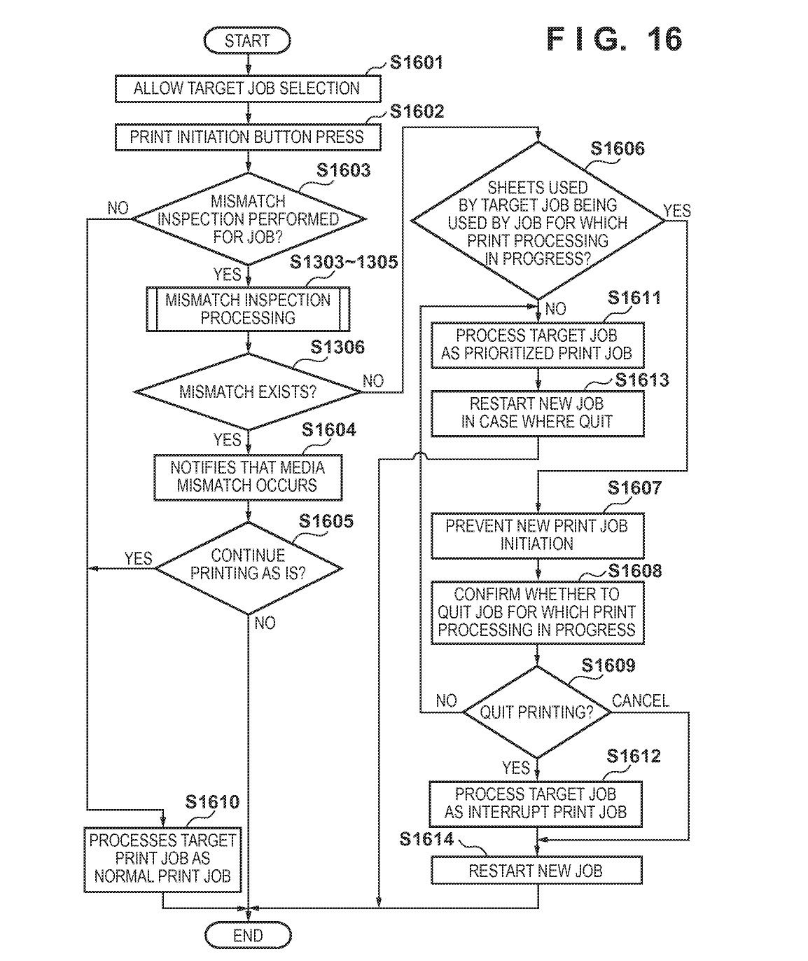

FIG. 16 is a flowchart for describing processing when a print job, for which a mismatch inspection is performed, is executed in the printing apparatus 103 according to the second embodiment.

Firstly, in step S1601, the control unit 1200 prompts the user for selection of a print job. This processing step is similar to step S1301 of FIG. 13. Next, the processing proceeds to step S1602, and the control unit 1200 receives a pressing of a print initiation button 704 (FIG. 7) of the console unit 220 by the user. With this, the processing proceeds to step S1603, and the control unit 1200 determines whether or not the print job selected in step S1601 by the user is a job for which the mismatch inspection is performed already. Here, the control unit 1200 stores the result of the performed mismatch inspection in the storage unit 230 in a set with the print job. With this, regarding jobs for which the mismatch inspection is once performed, a determination can be performed such as in step S1603. In step S1603, in a case where the control unit 1200 determines that it is a print job for which the mismatch inspection is yet to be executed, the processing proceeds to step S1610, the control unit 1200 processes the print job as a normal print job, and the processing completes.

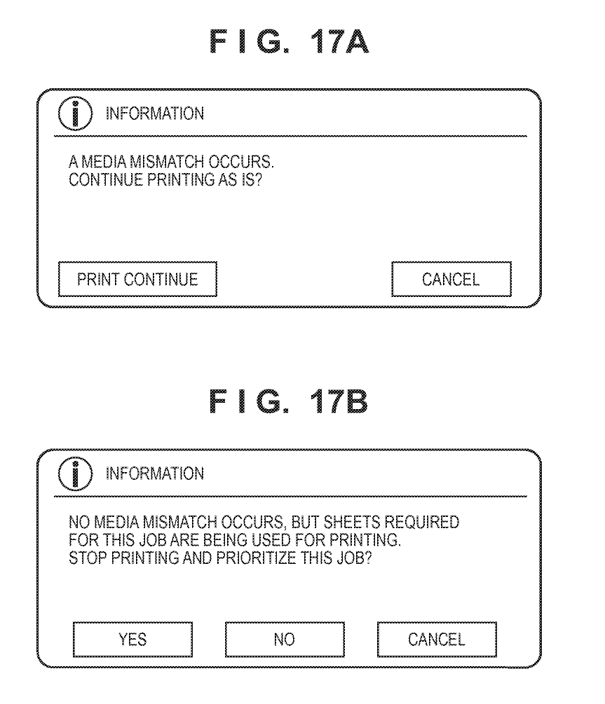

On the other hand, in a case where the control unit 1200, in step S1603, determines that it is a print job for which the mismatch inspection is executed, the control unit 1200 performs the mismatch inspection processing explained with FIG. 13 (step S1303 through step S1306). This processing is similar to the content explained with reference to FIG. 13. Here, in the processing of step S1306, in a case where it is determined that there is a mismatch, the processing proceeds to step S1604, and the control unit 1200 notifies the user to the effect that a media mismatch occurs by displaying a screen such as FIG. 17A on the touch panel unit of the console unit 220. Furthermore, the control unit 1200, in step S1605, allows the user to select whether to continue printing as is, or to stop the printing in FIG. 17A. In step S1605, when a “print continue” button is pressed and it is instructed that the printing be continued even though the mismatch occurs, the processing proceeds to step S1610, and the control unit 1200 processes the print job as a normal print job, and the processing completes. In such a case, the printing due to the print job, will be stopped due to running out of sheets if nothing is done. On the other hand, in a case where in step S1605 a “cancel” button is pressed and cancellation of the printing is instructed, the control unit 1200 completes the processing.

Meanwhile, in a case where it is determined that there is no mismatch in the processing of step S1306, the processing proceeds to step S1606, and the control unit 1200 determines whether or not the sheets used by the print job are being used by a job for which print processing is in progress. In a case where it is determined that the sheets are not being used in step S1606, the processing proceeds to step S1611, and the control unit 1200 processes the selected print job as a prioritized print job. In other words, if print processing is in progress currently for the job, the control unit 1200 controls so that that selected print job is executed after the termination of the print job for which print processing is in progress.

Meanwhile, in a case where it is determined in step S1606 that the sheets that the selected print job uses are used by the job for which print processing is in progress, the processing proceeds to step S1607, and the control unit 1200 prevents print processing for the new print job from being initiated until the end of the print job being printed currently. Then, the processing proceeds to step S1608, and the control unit 1200 displays on the touch panel unit of the console unit 220 a screen such as FIG. 17B, and allows the user to select whether or not to prioritize the printing of the print job for which print processing is in progress, or to cancel the execution of the print job for which print processing is in progress. In a case where it is determined in step S1609 not to cancel the execution of the print job for which print processing is in progress, the control unit 1200 moves the processing to step S1611, and executes the selected print job after the completion of the print job for which print processing is in progress. Then, in a case where a stop is put on the initiation of the new print job, the control unit 1200, in step S1613, restarts it. In such a case, there is the possibility that the printing will stop due to running out of sheets during execution of the selected print job, because the sheets that are to be used by the execution of the selected print job are used by the currently executing print job.

On the other hand, in a case where, in step S1609, the “yes” button of FIG. 17B is pressed, the print job for which currently print processing is in progress is stopped, and instruction is made to prioritize the printing of the selected print job, the processing proceeds to step S1612. In step S1612, the control unit 1200 processes the selected print job as an interrupt print job. In other words, control is performed so as to stop the execution of the print job for which currently print processing is in progress, and to execute the selected print job first. Then, the processing proceeds to step S1614, and the control unit 1200 restarts the execution of the new print job that was stopped. Note, when a “cancel” button of FIG. 17B is pressed in step S1609, it is determined that the execution of the selected print job be cancelled, the processing proceeds to step S1614, the control unit 1200 resumes the initiation of the new print job that was stopped, and the processing completes.

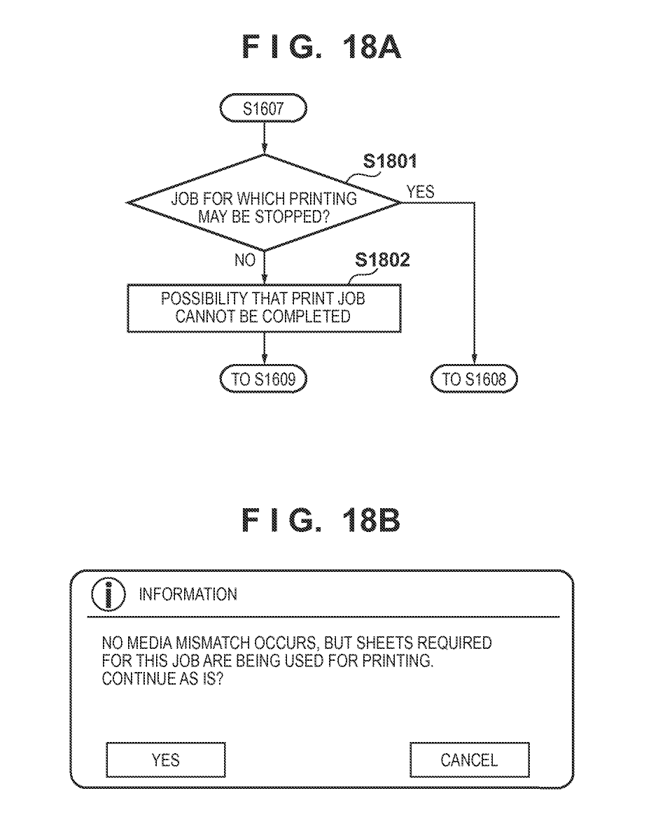

Note, there are print jobs out of print jobs for which print processing is in progress currently for which printing cannot be stopped. For example, if printing, for which a stapling instruction is made, is quit in process due to the previously described sheet processing apparatus 1220, the resulting document will be left in an incomplete state. Then, there is the possibility that the succeeding print job will fall into a state in which it cannot be processed. Also, in a case where the print job for which print processing is in progress is a print job for which print initiation is performed after having already performed the mismatch inspection, the execution of the print job cannot be stopped. Explanation will be given for such a case with reference to FIG. 18A.

FIG. 18A is a flowchart for describing processing executed continuing from step S1607 of FIG. 16.

After the control unit 1200 stops the initiation of the new print job in step S1607 of FIG. 16, the control unit 1200 determines whether or not, in step S1801, the print job for which print processing is in progress is a print job for which the printing may be stopped. In a case where the control unit 1200 determines in step S1801 that the print job may be stopped, the control unit 1200 advances to the processing of step S1608 of FIG. 16.

On the other hand, in a case where it is determined that the printing of the print job cannot be stopped in step S1801, the processing proceeds to step S1802, and the control unit 1200 notifies the user of the effect that there is the possibility that the print job cannot be completed by displaying on the display unit of the console unit 220 a screen such as FIG. 18B. Then, the user is allowed to select whether to cancel the print job for which print processing is in progress, or to continue the printing as is.

In this way it is possible to print a print job for which a mismatch inspection is performed prior to an influence occurring due to the job for which print processing is in progress, a print job queued in the print queue buffer, or the like, by printing preferentially the print job for which the mismatch inspection is performed. Because of this, it becomes possible to ensure the completion of the print job for which the mismatch inspection is performed.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-131053, filed Jun. 21, 2013, which is hereby incorporated by reference herein in its entirety.

What is claimed is:

1. A printing apparatus, comprising:
a holding unit configured to hold a job for which execution of printing is not instructed;
a storage unit configured to store a job for which execution of printing unit is instructed;
a determination unit configured to determine whether or not a sheet necessary to complete the job held in the holding unit is set in a sheet feed source; and
a display unit configured to display a job held in the holding unit and a determination result by the determination unit for the job,
wherein the display unit further notifies that a print job is stored in the storage unit, wherein the print job uses a sheet being to be used by the job for which it is determined by the determination unit that the sheet necessary to complete the job is set in the sheet feed source.

2. The printing apparatus according to claim 1,
wherein the determination result includes the existence or absence of a sheet deficiency and of a sheet designated by the job.

3. The printing apparatus according to claim 1, further comprising:
a selection unit configured to select a job that is to be executed from the jobs held in the holding unit;
a designation unit configured to designate execution of the job selected by the selection unit.

4. The printing apparatus according to claim 1, further comprising:
a setting unit configured to set a processing mode for a job, for which the determination by the determination unit is not made, which is held in the holding unit; and
a control unit configured to control so as to execute the job for which the determination by the determination unit is not made in accordance with the processing mode set by the setting unit.

5. The printing apparatus according to claim 1, wherein
the display control unit configured to make to be unconfirmed, and cause to be displayed on the display unit, the determination result by the determination unit in a case where the print job that uses a sheet being to be used by the job for which it is determined by the determination unit that the sheet necessary to complete the job is set in the sheet feed source is stored in the storage unit.

6. The printing apparatus according to claim 1, further comprising:
an instruction unit configured to allow a user to instruct whether or not, in a case where a sheet being to be used by the job for which it is determined by the determination unit that the sheet necessary to complete the job is set in the sheet feed source is used by a currently executing job, to cause the currently executing job to stop.

7. The printing apparatus according to claim 1,
wherein the holding unit is a hold queue and the storage unit is a print queue.

8. A method of controlling a printing apparatus, comprising:
holding a job for which execution of printing is not instructed in a holding unit;
storing a job for which execution of printing unit is instructed in a storing unit;
determining whether or not a sheet necessary to complete a job held in the holding unit is set in a sheet feed source;
displaying a job held in the holding unit and a determination result of the determination step for the job; and
notifying that a print job is stored in the storing unit, wherein the print job uses a sheet being to be used by the job for which it is determined by the determination unit that the sheet necessary to complete the job is set in the sheet feed source.

9. A non-transitory computer-readable storage medium storing a program for causing a computer to function as the printing apparatus according to claim 1.

10. A printing apparatus, comprising:
a storage unit configured to store a job;
an execution unit configured to execute, in accordance with an execution request of the job stored by the storage unit being received from a user, the job;
a printing unit configured to print an image on a sheet by executing the job with the execution unit;
a holding unit configured to hold attribute information indicating an attribute of a sheet accommodated in a sheet accommodation unit;
a determination unit configured to determine in accordance with an instruction from a user whether or not attribute information indicating an attribute of a sheet used by the job stored in the storage unit is held in the holding unit; and
a control unit configured to control so as to execute the job, for which the determination unit determined that the attribute information indicating the attribute of the sheet is held in the holding unit, preferentially over another job awaiting execution.
